(19) United States
(12) Patent Application Publication
(10) Pub. No.: US 2006/0247089 A1
(43) Pub. Date: Nov. 2, 2006

(54) Sun and planet gear transmission mechanism

(76) Inventors: Dong-Liang Guo, Jiaxing City (CN); Kang Lu, Jiaxing (CN); Min-Huang Lin, Jiaxing City (CN); Ta-Chun Song, Jiaxing City (CN)

Correspondence Address: TROXELL LAW OFFICE PLLC, SUITE 1404, 5205 LEESBURG PIKE, FALLS CHURCH, VA, 22041, US

(21) Appl. No.: 11/117,373

(22) Filed: Apr. 29, 2005

(51) Int. Cl. F16H 15/48

(52) U.S. Cl. 475/338

(57) ABSTRACT

The present invention is a gear system with a sun gear and planet gears used as a reduction gear, a gear speeder or a hub motor with a simple structure, a high reliability, a small size, a good speed ratio, a great efficiency and an output of a big torque.

### FIELD OF THE INVENTION

The present invention relates to a gear transmission mechanism; more particularly, relates to a mechanism to be used as a reduction gear with a simple structure, a high reliability, a small size, a good speed ratio, a great efficiency and an output of a big torque.

### DESCRIPTION OF THE RELATED ART

A prior art of “Planetary Gear System”, as described in the patent of U.S. Pat. No. 5,409,430, comprises a driven sun gear, an internal gear fixed on a case concentrically with the sun gear, a rotatable shaft concentric with the sun gear having a carrier, and planetary gears on the carrier for engagement with the sun gear and the internal gear. Therein, the internal gear is divided in the axial direction into first and second internal gear sections which are adjustable in their relative angle in the circumferential direction so as to reduce a backlash in the engagement with the planetary gears. Besides, the planetary gears comprise a large planetary gear part for engagement with the sun gear and a small planetary gear part concentric with the large planetary gear part for engagement with the internal gear. Hence the rotational speed can be improved.

Although the prior art of the planetary gear system can improve the rotational speed, the speed is improved by enlarging the circumference of the planetary gear, which produces interferences between the planetary gears and affects the rotational speed. So, the prior art does not fulfill users' requests on actual use.

### SUMMARY OF THE INVENTION

Therefore, the main purpose of the present invention is to be used as a reduction gear with a simple structure, a high reliability, a small size, a good speed ratio, a great efficiency and an output of a big torque.

To achieve the above purpose, the present invention is a sun and planet gear transmission mechanism, comprising a first roller body with a carrier and a teeth part near the carrier; a plurality of tower planet gears each having a large and a small gears as the large gear is in engagement with the first roller body; an annular gear as a sleeve on the surfaces of the small gears; a connection base with a second roller body at an end as connecting to the first roller body, being fixed on the carrier and being connected with an end of the small gear of each tower planet gear; and a shell for containing all of the above components, wherein the first roller body and the second roller body penetrated through and join flexibly on the two opposite ends of the shell and the annular gear is connected with the inner surface of the shell.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is a perspective view of the preferred embodiment according to the present invention;

FIG. 2 is an exploded view of the preferred embodiment according to the present invention;

FIG. 3 is a sectional view of the preferred embodiment according to the present invention;

FIG. 4 is a view of the first status of use of the preferred embodiment according to the present invention;

FIG. 5 is a view of the second status of use of the preferred embodiment according to the present invention;

FIG. 6 is a view of the third status of use of the preferred embodiment according to the present invention;

### DESCRIPTION OF THE PREFERRED EMBODIMENT

The following description of the preferred embodiment is provided to understand the features and the structures of the present invention.

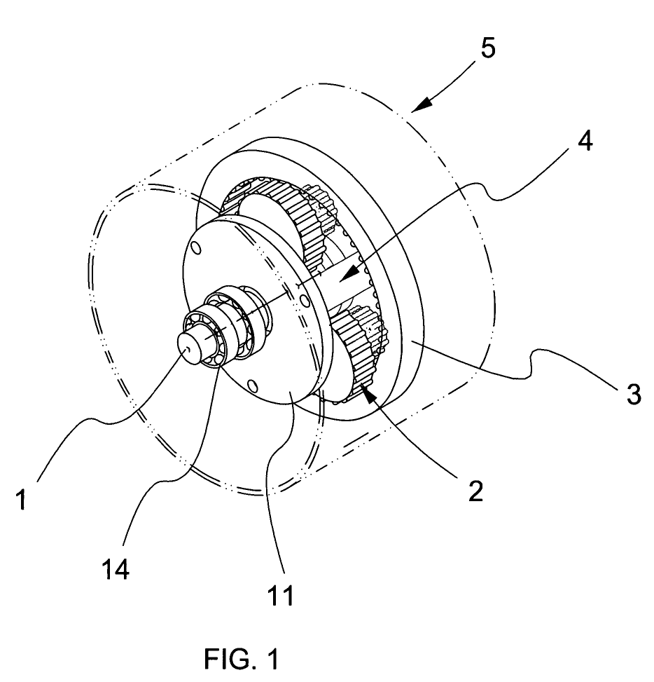

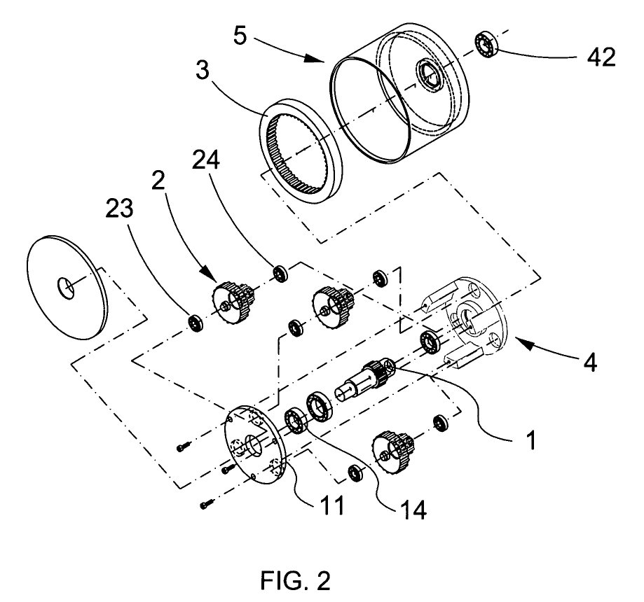

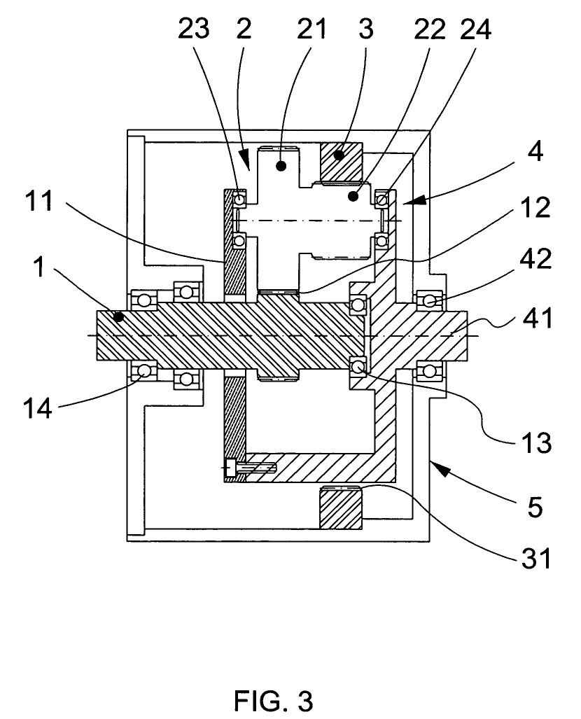

Please refer to FIG. 1 through FIG. 3, which are a perspective view, an exploded view and a sectional view of the preferred embodiment according to the present invention. As shown in the figures, the present invention is a sun and planet gear transmission mechanism, comprising a first roller body 1, a plurality of tower planet gears 2, an annular gear 3, a connection base 4 and a shell 5. The present invention can be used as a reduction gear with characteristics of a simple structure, a high reliability, a small size, a big speed ratio, a high efficiency, and an output of a great torque.

The first roller body 1 comprises a carrier 11; and a teeth part 12 is deposed on the first roller body 1 near the carrier Every tower planet gear 2 is deposed on the carrier 11 with a bearing 23 in between respectively. And each tower planet gear 2 comprises a large gear 21 and a small gear 22 where the large gear 21 is in engagement with the teeth part 12 of the first roller body 1.

The small gears 22 of the tower planet gears are sleeved with the annular gear on the outside surfaces; and a teeth part is set on the inner surface of the annular gear to be in engagement with the small gears

The connection base 4 is connected with the first roller body 1 with a bearing 13 in between and is fixed on the carrier 11 with a fixing member 43; an end of the small gear 22 of each tower planet gear 2 is connected with the connection base 4 with a bearing 24 in between; and, the connection base 4 comprises a second roller body 41 at an end.

The shell 5 is used to contain all the components and is penetrated by the first roller body 1 and the second roller body 41 of the connection base 4 which are flexibly joined on the two opposite end surfaces of the shell 5. In addition, at least a bearing 14 is set between the first roller body 1 and the shell 5; a bearing 42 is set between the second roller body 41 and the shell 5; and, the annular gear 3 is connected with the shell 5 on the inner surface of the shell 5. Hence, a novel sun and planet gear transmission mechanism is obtained.

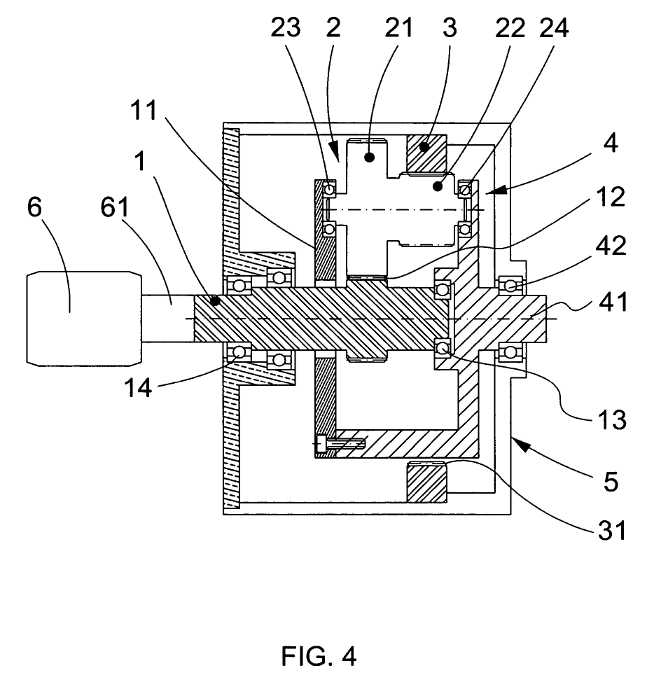

Please refer to FIG. 4 through FIG. 6, which are views of the first, the second and the third statuses of use of the preferred embodiment according to the present invention. As shown in the figures, the present invention of the sun and planet gear transmission mechanism can be used as a reduction gear where the radial dimension of the reduction gear is greatly shortened as the power density and the stiffness of the reduction gear is improved to be used in a high-effect electric vehicle, such as an electric bicycle, an electric motorcycle, an electric car, an electric wheelchair, etc., or to be used as a regular reduction gear. When used as a reduction gear, the first roller body 1 is connected with a shaft 61 of an actuator 6 (such as a motor). When the first roller body 1 rolls, the tower planet gear 2 is moved to roll the second roller body 41 with an output of a low rotational speed yet a big torque (as shown in FIG. 4).

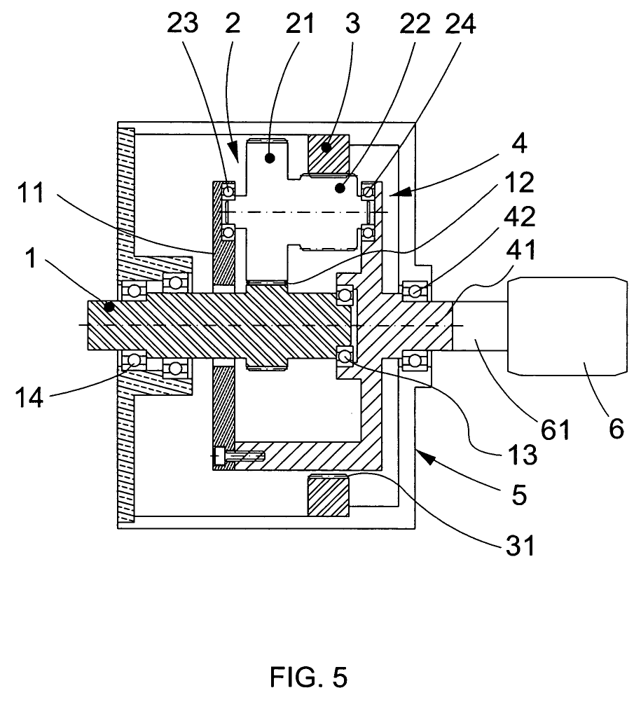

When used as a gear speeder, the second roller body 41 is connected with a shaft 61 of an actuator 6. When the second roller body 41 rolls, the tower planet gear 2 is moved to roll the first roller body 1 with an output of a high rotational speed yet a small torque (as shown in FIG. 5).

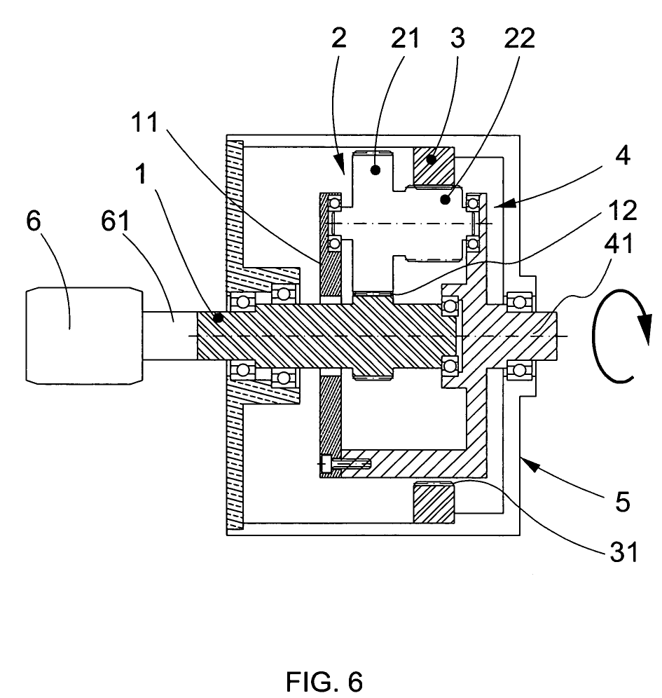

When used as a hub motor, the first roller body 1 is connected with a shaft 61 of an actuator 6 and the second roller body is fixed. Then the shell 5 is connected with the hub motor so that, when the first roller body 1 rolls, the tower planet gear 2 is moved to roll the shell with an output of a low rotational speed yet a big torque (as shown in FIG. 6).

To sum up, the present invention of a sun and planet gear transmission mechanism can be used as a reduction gear, a gear speeder or a hub motor with a simple structure, a high reliability, a small size, a good speed ratio, a great efficiency and an output of a big torque.

The preferred embodiments herein disclosed are not intended to unnecessarily limit the scope of the invention. Therefore, simple modifications or variations belonging to the equivalent of the scope of the claims and the instructions disclosed herein for a patent are all with in the scope of the present invention.

What is claimed is:

1. A sun and planet gear transmission mechanism, comprising:
a first roller body, wherein a carrier is deposed upon said first roller body and a teeth part is deposed near said carrier on the surface of said first roller body;
a plurality of tower planet gears, wherein said plurality of tower planet gears is deposed on said carrier and each tower planet gear comprises a large gear and a small gear and each large gear is in engagement with said teeth part of said first roller body;
an annular gear, wherein said small gears of said plurality of tower planet gears are sleeved with said annular gear on the outside surfaces of said small gears and a teeth part is set on the inner surface of said annular gear to be in engagement with said small gears;
a connection base, wherein said connection base is connected with said first roller body and is fixed on said carrier and an end of said small gear of each said tower planet gear is connected with said connection base and a second roller body is deposed at an end of said connection base; and
a shell, wherein every component of said sun and planet gear transmission mechanism is located in said shell and said shell is penetrated by said first roller body and said second roller body from two opposite end surfaces of said shell while said first roller body and said second roller are flexibly joined and said annular gear is connected with said shell on the inner surface of said shell.

2. The gear transmission mechanism according to claim 1, wherein a bearing is set between said first roller body and said connection base.

3. The gear transmission mechanism according to claim 1, wherein at least a bearing is set between said first roller body and said shell.

4. The gear transmission mechanism according to claim 1, wherein a bearing is set between each said tower planet gear and said carrier respectively; and wherein a bearing is set between each said tower planet gear and said connection base.

5. The gear transmission mechanism according to claim 1, wherein a bearing is set between said second roller body and said shell.

6. The gear transmission mechanism according to claim 1, wherein said connection base is fixed with said carrier by a fixing member.

7. The gear transmission mechanism according to claim 1, wherein said first roller body is connected with an actuator to obtain a reduction gear.

8. The gear transmission mechanism according to claim 1, wherein said second roller body is connected with an actuator to obtain a gear speeder.

9. The gear transmission mechanism according to claim 1, wherein said first roller body is connected with an actuator and said second roller body is fixed to obtain a hub motor.
